(19) United States
(12) Patent Application Publication
(10) Pub. No.: US 2012/0111426 A1
(43) Pub. Date: May 10, 2012

(54) DUAL STAGE SCREEN PACK WITH DECOMPRESSION FEATURE

(76) Inventor: Panos TRAKAS, Addison, IL (US)

(21) Appl. No.: 12/943,242

(22) Filed: Nov. 10, 2010

(51) Int. Cl. F16K 21/04

(52) U.S. Cl. 137/511

(57) ABSTRACT

An injection molding filtration apparatus having a filter, a decompression passage, and a filter check valve is used to filter molten polymer, while allowing for more complete decompression of the equipment downstream from the filter. The filter check valve and decompression passage are preferably internal to the filter element itself. In alternative embodiments, the decompression passage may be a separate bypass line that is arranged in a parallel configuration with an oppositely directed bypass check valve. Preferably, each of the check valves uses the molten polymer to push a movable body into a sealing engagement with an internal wall of the valve.

### BACKGROUND OF THE INVENTION

The present invention relates to the filtering of fluids and, in particular, filters for molten polymer and the decompression of equipment downstream from such filters.

Injection molding systems typically include a molding machine, which is a source of molten polymer put under very high pressure, at least one mold including at least one cavity formed therein, and an assembly such as a hot runner assembly which (at the time of molding) joins the two. U.S. Pat. No. Re. 41,280, issued to the Applicant and fully incorporated by reference herein, discloses details of a representative injection molding assembly, in that instance a multiple-nozzle manifold meant to inject molten polymer into multiple cavities in a mold.

Prior to delivering the molten polymer to the mold, it is desirable to filter the molten polymer. Such filters are known in the industry (See, e.g., U.S. Pat. No. 4,434,053 to Osuma-Diaz and U.S. Pat. No. 4,906,360 to the Applicant), and remove contaminants occurring in recycled polymer or “regrind” such as unmelted plastic granules, dirt, and metal shavings or filings which could clog the gates, damage the downstream system components or affect the quality of the molded part. After filtration, the molten polymer passes into the mold. But the interposition of the filter across the stream of pressurized molten polymer causes a pressure drop in the line.

Molten polymer is a compressible fluid. After the completion of a polymer injection into the mold, the mold is allowed to cool. The mold is opened and the molded part removed. If the equipment upstream from the mold (such as the hot runner system) is not depressurized, there is a danger that the gates will blow out and that molten polymer will “drool” out of the mold openings. The conventional way to minimize this “drool” is to have the molding machine draw back, exerting negative pressure in the line, prior to opening the mold. To date this decompression step has been incompatible with the provision of a polymer filter, as the pressure drop across the filter element is too great to allow the polymer downstream from the filter to significantly decompress. Thus injection molders have had to either put up with “drool” or forgo the filter. A need therefore persists for injection apparatus which can filter the molten polymer but which also permits molten polymer decompression after the injection step.

### SUMMARY OF THE INVENTION

In one aspect of the invention, filtration apparatus (such as a screen pack) for filtering molten polymer comprises a primary inlet, a primary outlet, a filter, and a filtration passage fluidly connecting the primary inlet and the primary outlet through the filter. The apparatus also has a decompression passage that connects the primary inlet and primary outlet and is operable to decompress the equipment downstream from the filter, including the machine nozzle and any hot runner assembly connecting to the mold. A valve is operable between a first position that forces polymer to flow through the preferably two-stage filter along the filtration passage from the primary inlet to the primary outlet, and a second position that permits polymer to flow from the primary outlet to the primary inlet along the decompression path, bypassing the filter and decompressing the downstream equipment.

In a further aspect of the invention, a method of using an injection molding filtration apparatus comprises the major steps of filtering molten polymer and thereafter decompressing the equipment downstream from the filter. The step of filtering includes the substeps of closing a check valve to close a decompression passage which circumvents the filter, and flowing polymer from the primary inlet toward the primary outlet along the filtration passage through the filter. The step of decompressing includes the substeps of opening the check valve to open the decompression passage and flowing polymer from the primary outlet toward the primary inlet through the decompression passage. The polymer downstream of the check valve pushes a second sealing surface of a check valve movable body away from a first sealing surface of the check valve, thereby opening the check valve and bypassing the filter.

Preferably, the valve is a filter check valve that is arranged along an axis. The filter has a cavity formed by a wall with an interior surface that receives unfiltered polymer from the primary inlet. The filter check valve is disposed to be radially inward from the interior surface of the filter wall, A first position of a movable body of the filter check valve is a forward position that is proximate to a filter check valve inlet and a second position thereof is a rear position that is remote from the filter check valve inlet.

More preferably, the apparatus has a decompression duct disposed on a central axis to be radially interior to the inside surface of the wall of the filter element. The forward end has an abutting surface adapted to receive the movable body of the check valve. An internal passage from a forward end of the shaft to a rear end of the shaft acts as the decompression passage, such that the filter check valve is forced closed in the forward position when a polymer flows through the filtration passage from the primary inlet toward the primary outlet and, and is pushed open to the rear position when the polymer flows through the internal passage from the primary outlet toward the primary inlet.

According to another aspect of the invention, injection molding filtration apparatus (such as a screen pack) has a primary inlet, a primary outlet, and a filtration passage in fluid communication with the two. The filtration passage has a preferably two-stage filter and a filter check valve that is open when a molten polymer flows from the primary inlet toward the primary outlet, and is closed when the polymer flows from the primary outlet toward the primary inlet.

In this embodiment, a bypass line is also provided which fluidly connects the primary inlet with the primary outlet. The bypass line has a bypass check valve that is closed when the polymer flows from the primary inlet toward the primary outlet and is open when the polymer flows from the primary outlet toward the primary inlet. Thus, the bypass and filtration check valves act in opposition one another, regardless of the direction of the fluid flow.

According to a further aspect of the invention, a method of using an injection molding apparatus includes the major steps of filtering a polymer and subsequently decompressing the equipment downstream from the filter. The method includes the substeps of closing a bypass check valve to close a bypass line which extends from the primary inlet to the primary outlet and which bypasses the filter. At this time, polymer flows from the primary inlet to the primary outlet through a filtration passage, as permitted by a filter check valve which is then in an open position.

The step of decompressing the downstream equipment includes the substeps of closing the filter check valve, opening the bypass check valve, and flowing the polymer from the primary outlet toward the primary inlet through the bypass line.

The present invention thus permits the filtration of molten polymer prior to its introduction into the machine nozzle, any hot runner assembly and the mold, and also allows the subsequent decompression of the polymer prior to opening the mold.

### BRIEF DESCRIPTION OF THE DRAWINGS

Further aspects of the invention and their advantages can be discerned in the following detailed description, in which like characters denote like parts and in which:

FIG. 1A is an axial sectional view of one embodiment of filtration apparatus according to the invention showing a closed bypass check valve and an open filter check valve;

FIG. 1B is an axial sectional view similar to FIG. 1A, but showing an open bypass check valve and a closed filter check valve;

FIG. 2 is a detail of FIGS. 1A and 1B, particularly illustrating the bypass and filter check valves, with the movable bodies removed to show detail;

FIG. 3 is a flow diagram showing a method of filtering and decompressing, using the embodiment shown in FIGS. 1A and 1B;

FIG. 4A is an isometric view of a filter with a portion of the check valve integrated into an end of the filter according to the embodiment in FIGS. 1A and 1B;

FIG. 4B is an axial sectional view of the filter apparatus according to the embodiment of FIG. 4A;

FIG. 4C is a detail of FIG. 4B, showing a view of the teeth and notches on the lands of the filter;

FIG. 5 is an axial sectional view of another embodiment of the invention;

FIG. 6A is an isometric view of a dual core shaft according to the embodiment in FIG. 5;

FIG. 6B is an axial sectional view of the shaft according to the embodiment of FIG. 6A;

FIG. 7A is an isometric view of a dual core filter having a first stage and a second stage according to the embodiment in FIG. 5;

FIG. 7B is an axial sectional view of the filter according to the embodiment of FIG. 7A and taken substantially along line 7B-7B of FIG. 7C;

FIG. 7C is an end view of the filter shown in FIG. 7A;

FIG. 8 is an axial sectional view showing a cylindrical body that surrounds the filter;

FIG. 9 is an axial sectional view of a fitting or adapter that mates with the body shown in FIG. 8; and

FIG. 10 is a flow diagram showing a method for filtering and decompressing molten polymer using the apparatus shown in FIG. 5.

### DETAILED DESCRIPTION

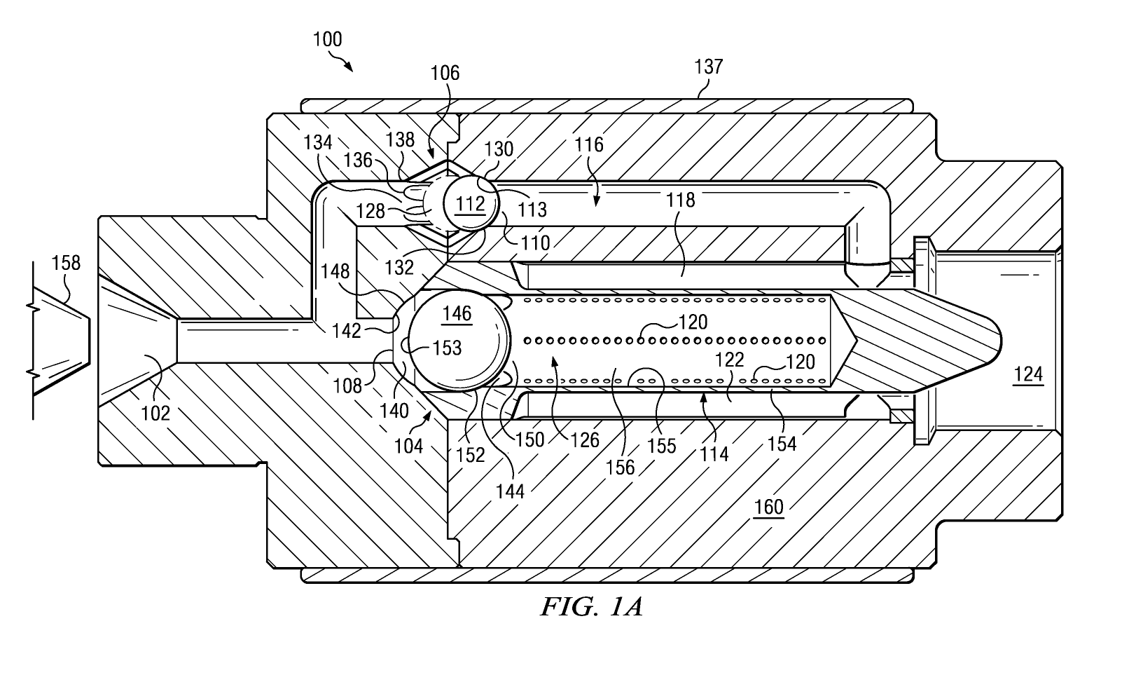

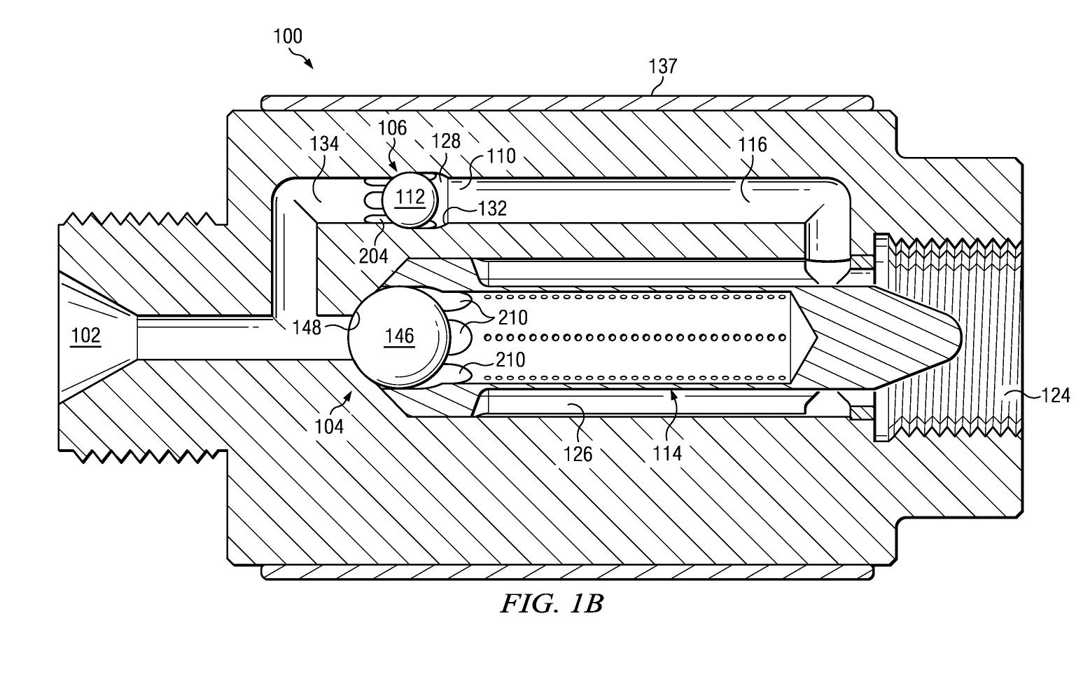

A filtration apparatus, or filter pack, indicated generally at 100 in FIGS. 1A and 1B, operates in a filtration mode where fluid passes through a filter, which removes contaminants, or in a decompression mode where the fluid flow is reversed. During decompression, at least a portion of the fluid flows in a reverse direction out of the filter pack and the pressure of the fluid downstream from the filter pack is allowed to subside. In the disclosed embodiments, the filtered fluid is generally contemplated as being a molten polymer and the filtration apparatus is used in conjunction with an injection molding system.

The filtration apparatus 100 has a primary inlet 102 connected to a polymer source 158, such as an injection molding machine. The primary outlet 124 is connected to a filtration passage 126 and a bypass line 116. The filtration passage 126 is fluidly connected between the primary inlet 102 and the primary outlet 124. As discussed herein, when two parts of the apparatus are said to be “fluidly connected,” this means that changes in the pressure and/or direction of the polymer flow in the first part affects the pressure and/or direction of the polymer flow in at least one section of the second part. Thus, by being “fluidly connected,” the physical aspects of the two parts are interrelated in some way. Further, “fluidly connected” is short form for “selectively fluidly connected”, as one or both of the filtration and decompression passages may be interrupted by a valve, depending on which embodiment of the invention is being considered and depending on the present step of the injection molding process.

The filtration passage 126 has a preferably two-stage filter 114 interposed across it and a filter check valve, indicated generally at 104, that is open when polymer flows from the primary inlet 102 toward the primary outlet 124. Correspondingly, the filter check valve 104 is closed when the polymer flows from the primary outlet 124 toward the primary inlet 102.

The bypass line 116 is also fluidly connected between the primary inlet 102 and the primary outlet 124 and has interposed across it a bypass check valve 106. The bypass check valve is closed when the polymer flows from the primary inlet 102 toward the primary outlet 124 and open when the fluid flow is reversed. Thus, the operation of the bypass check valve 106 and the filter check valve 104 ensure that the polymer flows either forward through the filtration passage 126 or backward through the bypass line 116. Polymer does not flow through both at the same time except during a time of transition when the valves are in the process of opening and closing.

Still referring to FIGS. 1A and 1B, the bypass check valve 106 has a bypass check valve inlet 110 which provides fluid communication from a bypass valve chamber 128 to the primary outlet 124. A first bypass sealing surface 130 of a chamber entry wall 132 surrounds the bypass check valve inlet 110. A bypass check valve movable body 112 within the bypass valve chamber 128 is reciprocally movable from a rear position that is remote from the entry wall 132 to a forward position that is proximate to the entry wall 132. The bypass check valve movable body 112 is preferably spherical or cone-shaped.

The bypass check valve movable body 112 has a second bypass sealing surface 113 that seals with the first bypass sealing surface 130 when the movable body 112 is in the forward position. A bypass check valve outlet 134 provides fluid communication between the bypass valve chamber 128 and the primary inlet 102 through an exit opening 136 in an exit wall 138 of the bypass valve chamber 128. Thus, as polymer flows from the primary inlet 102 toward the primary outlet 124, the bypass check valve movable body 112 moves to the forward position and the second bypass sealing surface 113 mates with the first bypass sealing surface 130, sealing the bypass check valve 106 and closing the bypass line 116. As a result, the polymer is forced through the filtration passage 126 and filter 114. See FIG. 1A.

The filtration apparatus preferably further includes a heat-conductive band heater 137 which jackets a body 160 of the pack 100. This maintains the polymer flowing through the pack 100 at the correct processing temperature.

The filter check valve 104 is similar in function and structure to the bypass check valve 106 except that it is directionally reversed, i.e., it allows polymer to flow in the opposite direction of the bypass check valve 106. See FIG. 1B. The filter check valve 104 has a filter check valve inlet 108 that provides fluid communication between the primary inlet 102 and a filter valve chamber 140. A first filter valve sealing surface 142 of an entry wall 148 surrounds the filter check valve inlet 108.

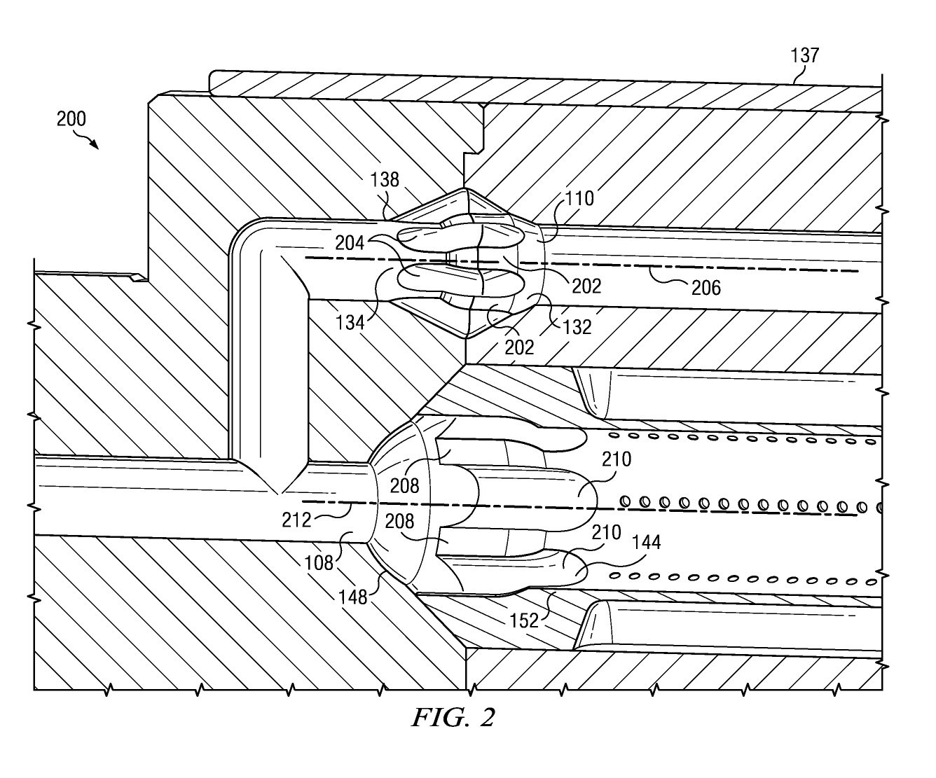

Referring to FIG. 2, the bypass valve chamber 128 preferably has a plurality of bypass check valve ridges 202 that extend from the entry wall 132 to the exit wall 138. These ridges 202 constrain the movement of the bypass check valve movable body 112 along a path of motion. More preferably, at least one of a plurality of grooves or passages 204 is spaced from another by the bypass check valve ridges 202. The passages 204 allow the polymer to flow between the bypass check valve inlet 110 and the bypass check valve outlet 134 when the bypass check valve movable body 112 is not in the forward position shown in FIG. 1A. Even more preferably, the passages 204 are circumferentially disposed around an axis 206 that is defined by the path taken by the bypass check valve movable body 112 (FIGS. 1A and 1B) as it moves between the rear to the forward positions.

A filter check valve movable body 146 (such as a sphere) is reciprocally movable within the filter valve chamber 140 between a rear position that is proximate to the entry wall 148 (FIG. 1B) and a forward position remote from the entry wall 148 (FIG. 1A). More preferably, neither the filter check valve 104 nor the bypass check valve 106 uses a spring, incline, or decline to bias the movable bodies 112, 146 to either the rear or forward positions. Preferably, the movable bodies 112, 146 are pushed to the forward position by the polymer upstream of the bodies 112, 146 and pushed to the rear position by the polymer downstream of the bodies 112, 146.

The filter check valve movable body 146 has a second filter valve sealing surface 153 that seals with the first filter valve sealing surface 142 when the movable body 146 is in the rear position. A filter check valve outlet 144 provides fluid communication between the filter valve chamber 140 and the primary outlet 124 through an exit opening 150 in an exit wall 152 of the filter valve chamber 140. The filter check valve outlet 144 is in fluid communication with the filter 114.

As above and referring again to FIG. 2, the filter valve chamber 140 preferably has a plurality of filter valve ridges 208 that extend from the entry wall 148 to the exit wall 152. These ridges 208 constrain the movement of the filter check valve movable body 146 along a path of motion, which in the illustrated embodiment is coaxial with axis 212.

One or more of a plurality of filter check valve passages 210 are spaced from each other by the filter valve ridges 208. As with the bypass valve passages 204, the filter check valve passages 210 allow the polymer to flow between the filter check valve inlet 108 and the filter check valve outlet 144 when the filter check valve movable body 146 is not in the rear position (FIG. 1A). Preferably, the passages 210 are circumferentially disposed around an axis 212 defined by the path taken by the filter check valve movable body 146 as it moves between the rear to the forward positions.

The filter 114 is preferably a two-stage filter which has an internal cavity 156 that is formed by at least a portion of an interior surface 155 of a wall 154. The first filter stage is formed by a plurality of holes 120 which are formed in the wall 154. In operation, the polymer flows through the filter check valve 104 when the filter check valve movable body 146 is not in the rear position, into the internal cavity 156, and through the plurality of holes 120. Once the polymer passes through the holes 120, it flows through first stage filter outlet passages 118 that are aligned with but spaced from axis 212 and are circumferentially spaced around the filter. Larger-size particulate contaminants such as dirt, plastic particles, or metal filings are retained in the internal cavity 156 of the filter 114.

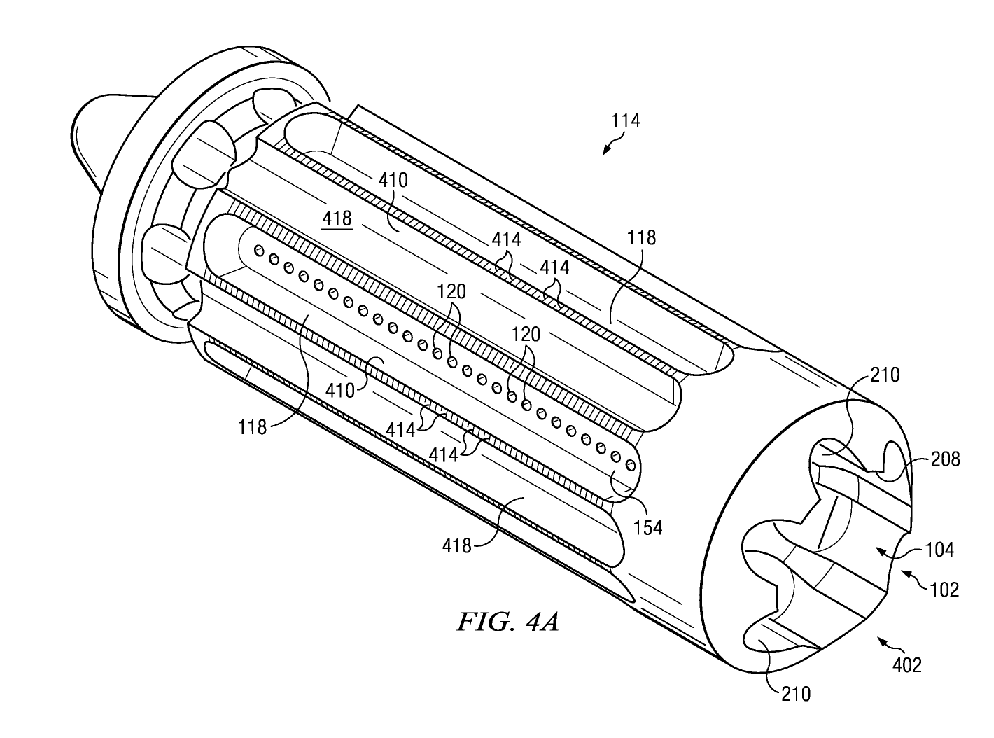

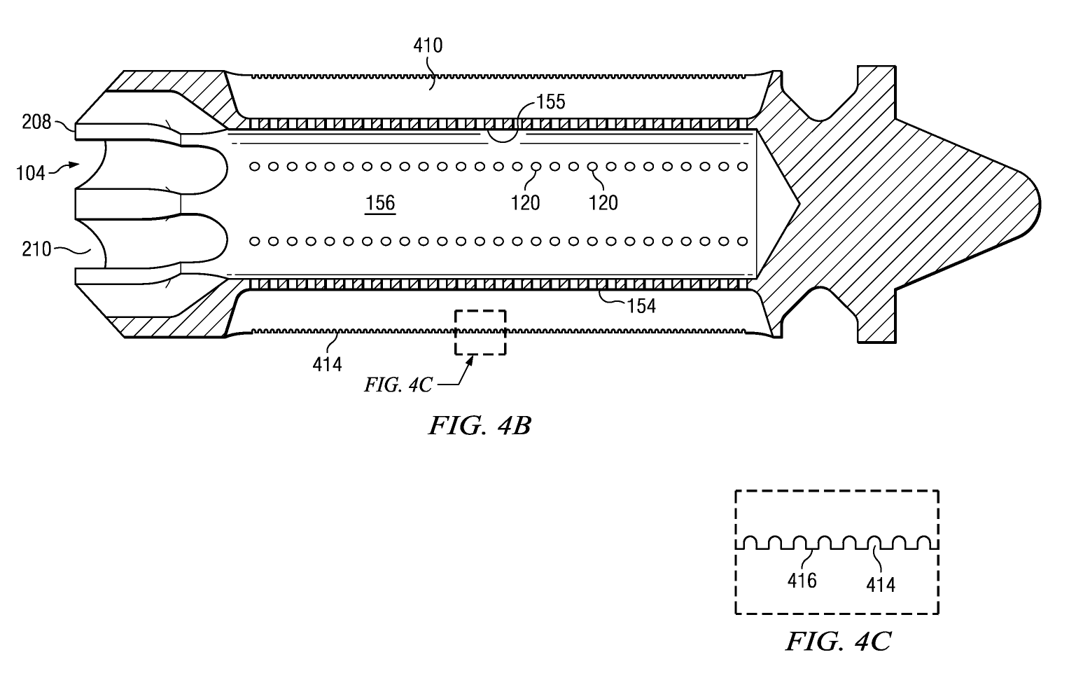

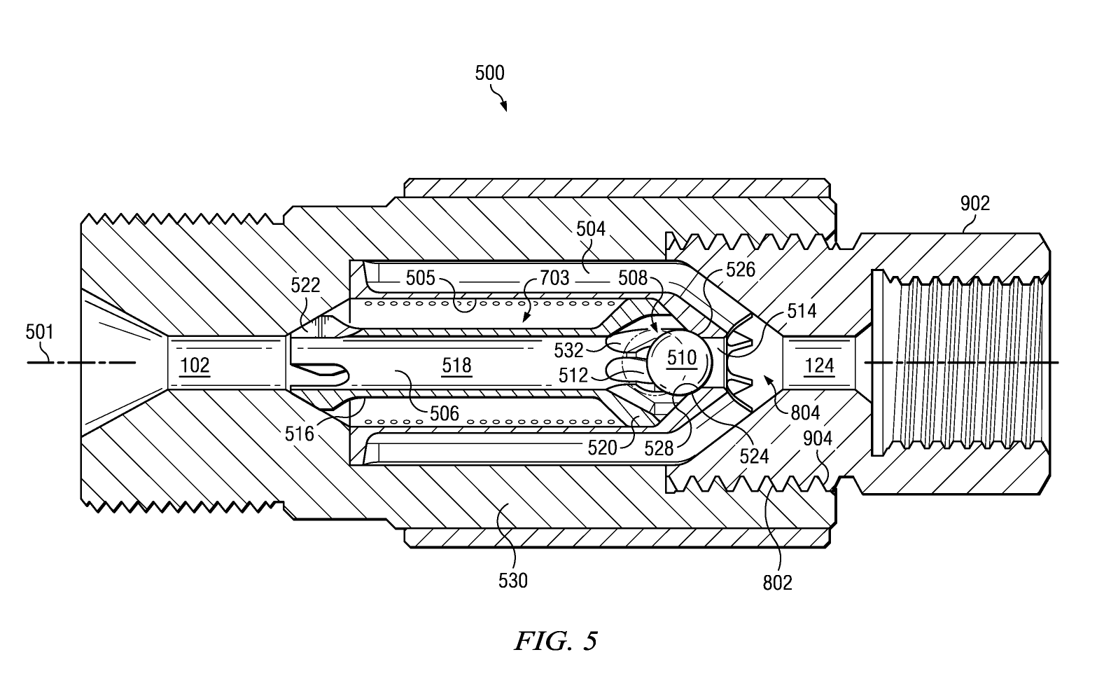

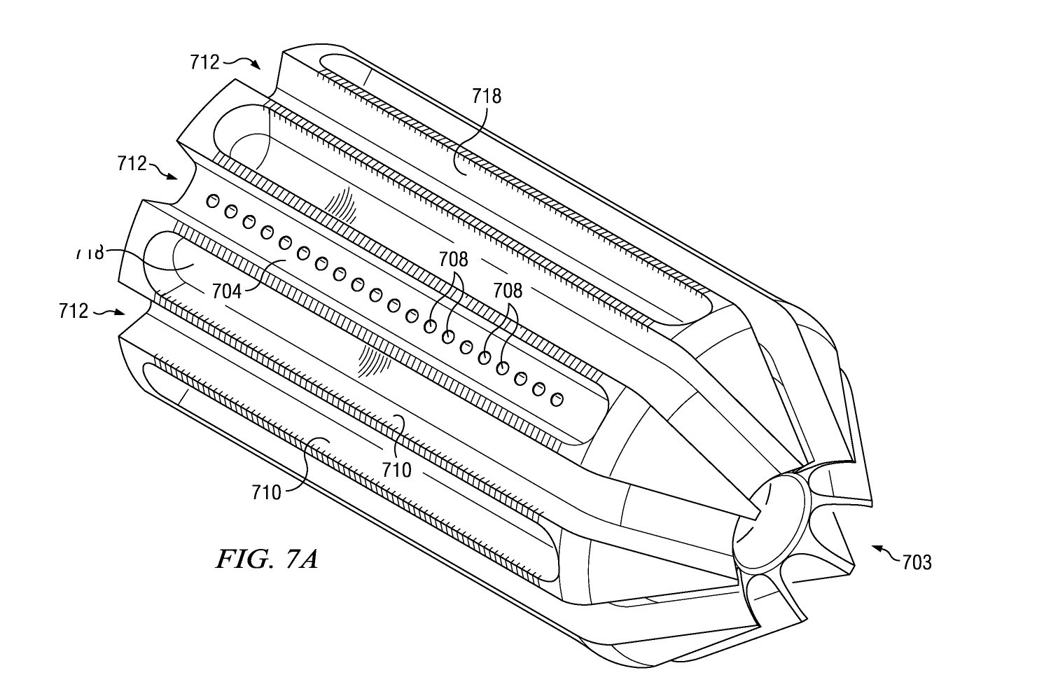

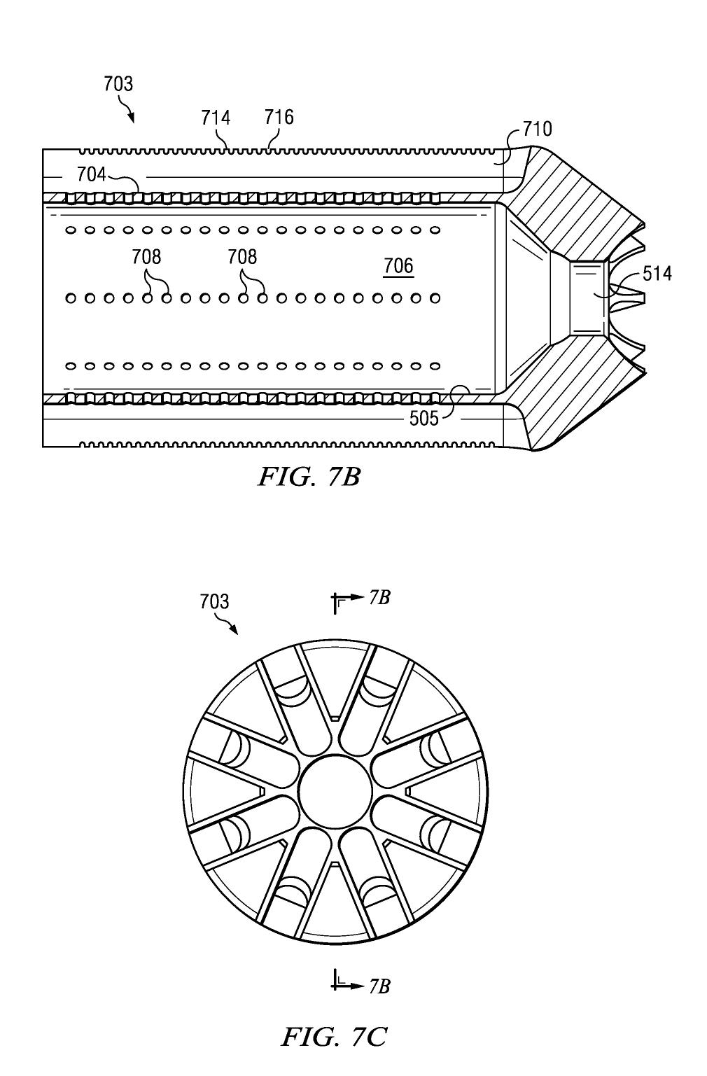

At least a portion of the filter check valve 104 is preferably integrated into the filter 114. As shown in FIGS. 2 and 4A, the ridges 208 contacted by the filter valve movable body 146 (FIGS. 1A and 1B) and the passages 210 through which the polymer flows can be formed into one end 402 of the filter 114. This is particularly desirable, since it increases reliability and simplifies maintenance.

[check numbers] As shown in FIGS. 4A-4C and 7A-7C, the filter 114, 703 is preferably a multi-stage filter having at least a first stage and a second stage. The first stage has a wall 154, 704, an internal cavity 156, 706 that is radially inward from inside surface 155, 505 of the wall 154, 704, and a plurality of holes 120, 708 in the wall 154, 704. The second stage has a plurality of circumferentially spaced radially extending lands 410, 710 that are integral with and extend radially outward from the wall 154, 704. One or more inlet channels 118, 712 are formed between the lands 410, 710 such that each of the holes 120, 708 are disposed to be open to a respective inlet channel 118, 712. The radially outward surfaces of the lands 410, 710 have a plurality of teeth 414, 714 that, when the filter pack is assembled, abut the inside surface of a circumferential body 160, 530 (see FIGS. 1A and 5). Each tooth 414, 714 is separated by a notch 416, 716, and the teeth 414, 714, together with the circumferential body 160, form a second plurality of openings. The openings formed by notches 416, 716 communicate the inlet channels 118, 712 with adjacent outlet channels 418, 718 which are angularly spaced from and act to separate the inlet channels 118, 712. The outlet channels 418, 718 in turn are in fluid communication with the primary outlet 124. Thus, the polymer can flow through the plurality of holes 120, 708 of the first stage, into the inlet channels 118, 712, over the lands 410, 710 through the second plurality of openings formed by notches 416, 716, into the outlet channels 418, 718, and toward the primary outlet 124.

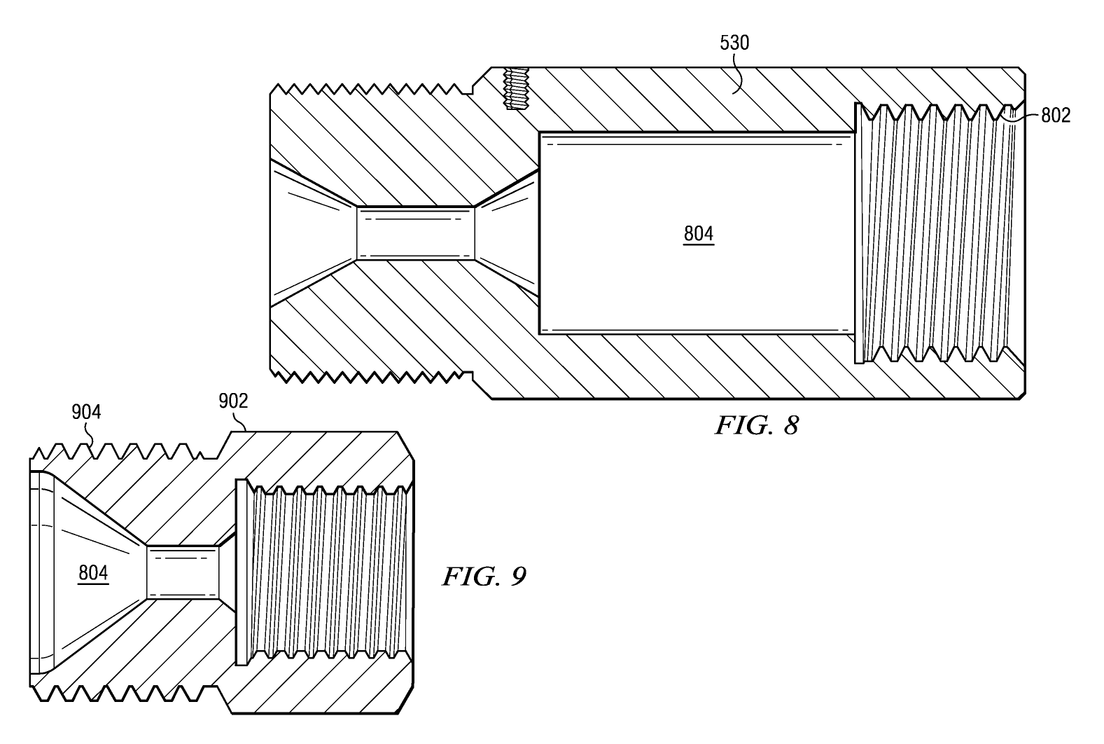

Referring to FIGS. 5, 8, and 9, in one embodiment the body 530 has a first connection 802. A removable fitting, adapter or cap 902 with a second connection 904 that is complementary to the first connection 802 is sized to mate with the body 530 such that the filter 703 is removable from the body 530 when the fitting 902 is removed. Body 530 and fitting 902 together define a chamber 804 in which the filter 703 and the filter check valve 508 reside.

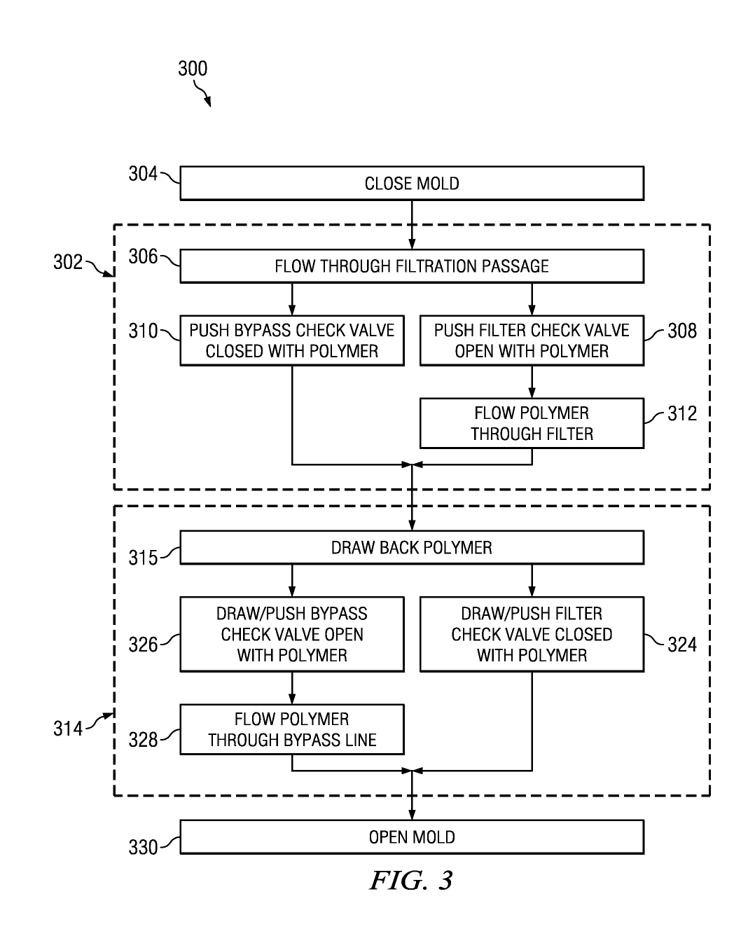

Referring to FIG. 3, a first method (300) of using an injection molding filtration apparatus 100 includes the major steps of filtering (302) the polymer while an injection operation is taking place, and thereafter decompressing (314) the molten polymer downstream from the filter pack 100. A selected mold is closed at (304). An injection molding machine 158 introduces pressurized polymer into the primary inlet 102, flowing (306) the polymer from the primary inlet 102 toward the primary outlet 124 through the filtration passage 126 and through (312) the filter 114. During this time the filter check valve 104 is forced (308) to an open position and the bypass check valve 106 is pushed (310) to a closed position. The bypass check valve 106 thereby closes a bypass line 116 from the primary inlet to the primary outlet.

After injection is completed, it is desirable to decompress (314) the molten polymer downstream from the filter pack 100 prior to opening the mold. This is accomplished by actuating the injection molding machine to draw back (315), thereby inducing molten polymer to flow back toward the primary inlet 102. Downstream molten polymer then pushes open (326) the bypass check valve 106 and preferably pushes closed (324) the filter check valve 104. Polymer may then flow (328) through the bypass line 116. Subsequent to decompression (314) the mold may be opened (330).

There is the possibility that the movable body 146 will not seal with wall 148 in the decompression step 314. This depends on the relative values of the pressure drop across the filter and the pressure drop occurring in the bypass line 116. If, as might occur if the filter is clogged, there is a much larger pressure drop across it than will be experienced through the bypass line 116, the polymer will largely flow through bypass line 116 rather than across the filter, and the movable body 146 may not be displaced enough or at all to seal with wall 148.

Referring to FIG. 5, an alternative embodiment of a filtration apparatus or pack, indicated generally at 500, for filtering molten polymer has a primary inlet 102, a primary outlet 124, a two-stage coaxial filter 703, and a filtration passage 504 fluidly connecting the primary inlet 102 with the primary outlet 124. The apparatus 500 also has an interiorly disposed decompression passage 506 that connects the primary inlet 102 with the primary outlet 124 and is operable to decompress the equipment downstream from the pack 500. A single valve 508 reciprocally operates between a first position, in which movable body or ball 510 is in the position shown, and a second position, in which ball 510 may take the position shown in dotted line. The first position forces polymer to flow from the primary inlet 102 to the primary outlet 124 through the filter 703 along the filtration passage 504. The second position permits polymer to flow from the primary outlet 124 to the primary inlet 102 along the decompression path 506, thereby decompressing equipment downstream from screen pack 500, and the polymer will preferentially flow along this path rather than along the filtration path because there is not a large pressure drop created by an interposed filter element.

Preferably, the filter 703 is cylindrical and arranged along an axis 501 and has a wall 704 with an interior surface 505 (see also FIG. 7B) for receiving unfiltered fluid polymer from the primary inlet 102 and an exterior in fluid communication with the primary outlet 124. Preferably, the valve 508 is a filter check valve that is disposed on the filter pack axis at a position axially forward from most of the interior surface 505 of the wall 704 of the filter 703.

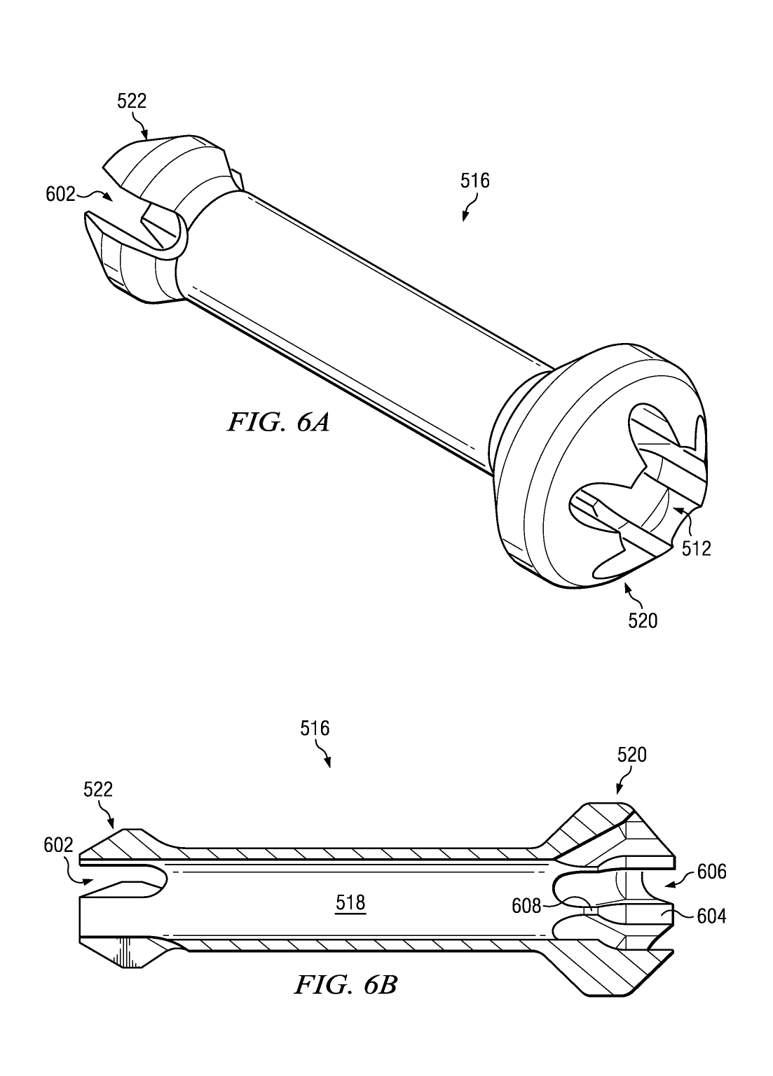

More preferably, the pack 500 has a decompression duct 516 disposed on the axis 501 to be radially inward of the interior surface 505 of the wall 704 of the filter 703. A forward end 520 of the duct 516 has an abutting surface 608 (see FIG. 6B) to receive the movable body 510 of the check valve 508. In an alternative embodiment (not shown) the rear end 522 of duct 516 may be enlarged to incorporate a check valve chamber, which would include an abutting surface for receiving the ball or movable body 510.

Even more preferably, the duct 516 has the abutting surface 608 in the forward end and an internal passage 518 from a forward end 520 of the duct 516 to a rear end 522 of the duct. At least a portion of the duct 516 is axially radially inward from the interior surface 505 of the filter 703. The internal passage 518 defined by duct 516 acts as the main component of the decompression passage 506. Thus, the filter check valve 508 closes, with ball 510 in the forward position, when a polymer flows from the primary inlet 102 toward the primary outlet 124 down passage 518, and opens, with ball 510 in the rear position, when the polymer flows from the primary outlet 124 toward the primary inlet 102.

A first check valve sealing surface 524 of an entry wall 526 surrounds the check valve inlet 514 and a second sealing surface 528 of the filter check valve movable body 510 is sealable with the first check valve sealing surface 524 when the movable body 510 is in the forward position.

The filter pack 500 has a technical advantage in that its structure includes only one movable body or ball 510 rather than two, saving manufacturing and maintenance costs. The filter pack 500 is also more compact than the previously described embodiment in that no separate bypass line has to be provided for.

In a preferred embodiment and referring to FIGS. 6A and 6B, the forward end 520 of the duct 516 includes a portion of the filter check valve chamber 512 and the rear end 522 includes one or more holes or channels 602 that form a part of the filtration passage 504. This allows polymer to flow from the rear end 522 of the duct 516, and through the holes or channels 602 to the outer surface of the shaft 516 and to the filter 502.

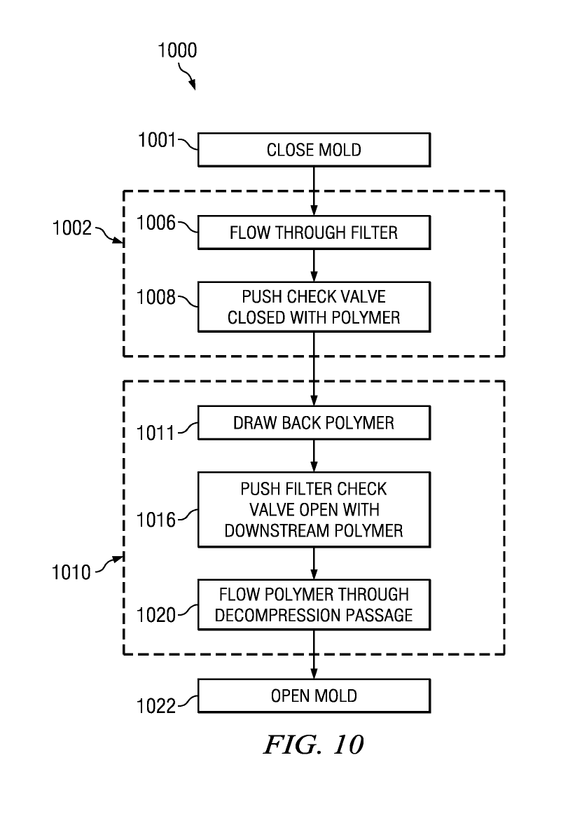

A method of using the injection molding apparatus 500, indicated generally at (1000) in FIG. 10, includes the major steps of filtering (1002) the molten polymer during an injection molding operation, and subsequently decompressing (1010) the equipment downstream from the filter pack 500.

Preliminarily the mold is closed (1001) and equipment such as a sprue bar assembly is connected to it. At step 1002 an injection molding machine introduces molten polymer at high pressure to the primary inlet 102, flowing (1006) polymer from the primary inlet 102 toward the primary outlet 124 through the filter 114, and closing (1008) a check valve 508 to close a decompression passage which otherwise would circumvent the filter 502.

In the decompression phase 1010, the injection molding machine draws polymer back (1011) from the primary inlet 102. Downstream molten polymer will then push (1016) the filter check valve 508 open, opening the decompression passage 506. Polymer then flows (1020) through the decompression passage 506. The substep of pushing (1016) involves displacing a second sealing surface 528 of the check valve movable body 510 away from the first sealing surface 524 of the check valve 508, with the aid of polymer downstream of the check valve 508. This opens the check valve 508 and bypasses the filter 703. Polymer then flows (1020) through the decompression passage 506, decompressing the equipment downstream from the filter pack 500. After decompression (1010) the mold may be opened (1022).

In summary, the described apparatus and method permit molten polymer to be filtered and also allows the equipment downstream from the filter pack to be decompressed, thereby eliminating or reducing the amount of “drool” which would otherwise occur. While illustrated embodiments of the present invention have been described and illustrated in the appended drawings, the present invention is not limited thereto but only by the scope and spirit of the appended claims.

I claim:

1. Filtration apparatus for filtering molten polymer comprising:
a primary inlet;
a primary outlet;
a filter;
a filtration passage fluidly connecting the primary inlet with the primary outlet;
a decompression passage connecting the primary inlet and to the primary outlet and operable to decompress the equipment downstream from the apparatus; and
a valve operable between a first position permitting polymer to flow through the filter along the filtration passage from the primary inlet to the primary outlet, and a second position permitting polymer to flow in a direction from the primary outlet to the primary inlet along the decompression passage, thereby decompressing equipment downstream from the apparatus.

2. The apparatus of claim 1, wherein the filter is arranged along an axis and has a cavity formed by a wall having an interior surface for receiving unfiltered fluid polymer from the primary inlet and having an exterior in fluid communication with the primary outlet, the valve being a filter check valve disposed to be radially inward from the interior surface of the filter wall, the first position of the valve being a forward position proximate to a filter check valve inlet, the second position being a rear position remote from the filter check valve inlet, and the filter check valve further comprising a movable body reciprocally movable within a filter valve chamber between the forward and the rear positions.

3. The apparatus of claim 2, further comprising a duct disposed on a central axis to be radially interior to the inside surface of the wall of the filter, one of a forward end or a rear end of the duct having an abutting surface to receive the movable body of the check valve, wherein the filter is cylindrical and is disposed around the axis.

4. The apparatus of claim 3, the shaft further comprising the abutting surface in the forward end and an internal passage from the forward end of the shaft to the rear end of the duct, the internal passage acting as the decompression passage, such that the filter check valve is disposed to be closed in the forward position when a polymer flows from the primary inlet toward the primary outlet and open in the rear position when the polymer flows from the primary outlet toward the primary inlet.

5. The apparatus of claim 4, further comprising
a first sealing surface of an entry wall surrounding the filter check valve inlet; and
a second sealing surface of the filter check valve movable body sealable with the first check valve sealing surface when the filter check valve movable body is in the forward position.

6. The apparatus of claim 5, the rear end of the duct further comprising at least one of a hole or a channel, the at least one hole or channel forming a portion of the filtration passage.

7. The apparatus of claim 3, further comprising
a body formed around the filter and having a first connection; and
a removable fitting having a second connection complementary to the first connection, the fitting being sized such that when the fitting is removed, the filter is removable from the body.

8. The apparatus of claim 3, the filter further comprising
a first stage having
a wall;
an internal cavity radially inward from the wall;
a plurality of holes in the wall;
a second stage having
a plurality of circumferentially spaced radially upstanding lands affixed to and disposed radially outward from the wall of the first stage;
an inlet channel between at least two of the lands, at least one of the holes disposed to be open to the inlet channel;
a plurality of teeth on the radially outward surface of each land, each tooth being separated from an adjacent tooth by a notch;
a circumferential body having an inside surface that abuts a radially outward surface of the teeth, such that the teeth, the lands, and the inside surface form a second plurality of openings; and
an outlet channel between at least two of the lands, the outlet channel disposed to be open to at least one of the second plurality of openings and in fluid communication with the primary outlet;
such that polymer may flow through the plurality of holes of the first stage, through the inlet channel, over the lands through the second plurality of openings, and toward the primary outlet when the filter check valve movable body is in the forward position.

9. The apparatus of claim 3, further comprising
a filter check valve outlet;
a filter valve chamber extending from the filter check valve inlet to the filter check valve outlet;
a plurality of ridges in a filter valve chamber constraining movement of the filter check valve movable body along a path of motion; and
at least one of a plurality of passages spaced from each other by the ridges, the passages providing fluid communication between the filter check valve inlet and the filter check valve outlet.

10. A method of using an injection molding apparatus having a primary inlet and a primary outlet, the method comprising the steps of:
filtering molten polymer, the step of filtering comprising the substeps of
flowing polymer from the primary inlet toward the primary outlet along a filtration passage through the filter, the check valve disposed to be in a closed position; and
closing a check valve to close a decompression passage which circumvents a filter;
decompressing equipment downstream from the filter, the step of decompressing comprising the substeps of
flowing polymer from the primary outlet toward the primary inlet through the decompression passage; and
opening the check valve to open the decompression passage.

11. The method of claim 10, wherein the substep of opening the check valve comprises pushing a second sealing surface of a check valve movable body away from a first sealing surface of the check valve with polymer downstream of the check valve, thereby opening the check valve and bypassing the filter.

12. The method of claim 10, the step of decompressing further comprising the substep of flowing polymer around the check valve movable body through at least one channel in fluid communication with the primary inlet.

13. The method of claim 10, the step of filtering further comprising the substep of
pushing a second sealing surface of the check valve movable body into engagement with a first sealing surface of the check valve with polymer upstream of the filter check valve, thereby closing the check valve.

14. The method of claim 10, wherein during said step of decompressing, the polymer bypasses the filtration passage through a bypass line in fluid communication with the primary inlet and the primary outlet.

15. The method of claim 10, further comprising the step of
during said step of decompressing, flowing polymer through a portion of the decompression passage disposed to be radially inward of the filter.

16. Injection molding filtration apparatus having a primary inlet and a primary outlet, comprising:
a filtration passage fluidly connecting the primary inlet with the primary outlet and having
a filter check valve disposed to be in an open position when molten polymer flows from the primary inlet toward the primary outlet and in a closed position when the polymer flows from the primary outlet toward the primary inlet; and
a filter;
a bypass line fluidly connecting the primary inlet with the primary outlet, the bypass line having
a bypass check valve disposed to be in the closed position when the polymer flows from the primary inlet toward the primary outlet and in an open position when the polymer flows from the primary outlet toward the primary inlet.

17. The apparatus of claim 17, the bypass check valve further comprising
a bypass check valve inlet providing fluid communication from a bypass valve chamber to the primary outlet, a first bypass sealing surface of an entry wall surrounding the bypass check valve inlet;
a bypass check valve outlet providing fluid communication from the bypass valve chamber to the primary inlet through an exit opening in an exit wall of the bypass valve chamber; and
a bypass check valve movable body reciprocally movable within the bypass valve chamber from a rear position remote from the entry wall to a forward position proximate to the entry wall, the bypass check valve movable body having a second bypass sealing surface sealable with the first bypass sealing surface when the bypass check valve movable body is in the forward position.

18. The apparatus of claim 18, further comprising a plurality of ridges in the bypass valve chamber extending from the entry wall to the exit wall that constrain movement of the bypass check valve movable body along a path of motion.

19. The apparatus of claim 19, further comprising at least one of a plurality of passages spaced from each other by the ridges, the passages providing fluid communication between the bypass check valve inlet and the bypass check valve outlet when the bypass check valve movable body is not in the forward position.

20. The apparatus of claim 20, wherein the passages are circumferentially disposed around an axis defined by a path of motion taken by the bypass check valve movable body from the rear to the forward positions.

21. The apparatus of claim 17, wherein the bypass check valve does not comprise a spring, incline, or decline to bias the bypass check valve movable body to either the rear position or forward position.

22. The apparatus of claim 17, wherein a portion of the filter check valve is integrated into an end of the filter.

23. The apparatus of claim 17, wherein the filter check valve further comprises
a filter check valve inlet providing fluid communication from the primary inlet to a filter valve chamber, a first filter valve sealing surface of an entry wall surrounding the filter check valve inlet;
a filter check valve outlet providing fluid communication from the filter valve chamber to the primary outlet through an exit opening in an exit wall of the filter valve chamber and being in fluid communication with the filter; and
a filter check valve movable body reciprocally movable within the filter valve chamber from a rear position proximate to the entry wall to a forward position remote from the entry wall, the filter check valve movable body having a second filter valve sealing surface sealable with the first filter valve sealing surface when the filter check valve movable body is in the rear position.

24. The apparatus of claim 24, further comprising a plurality of ridges in the filter valve chamber extending from the entry wall to the exit wall that constrain movement of the filter check valve movable body along a path of motion.

25. The apparatus of claim 25, further comprising at least one of a plurality of passages spaced from each other by the ridges, the passages providing fluid communication between the filter check valve inlet and the filter check valve outlet when the filter check valve movable body is not in the rear position.

26. The apparatus of claim 26, wherein the passages are circumferentially disposed around an axis defined by a path of motion taken by the filter check valve movable body from the rear to the forward positions.

27. The apparatus of claim 17, the filter further comprising a wall, an internal cavity, at least a portion of the internal cavity formed by an interior surface of the wall, and a plurality of holes in the wall, such that the fluid flows through the filter check valve when the filter check valve movable body is not in the rear position, into the internal cavity, and through the plurality of holes.

28. The apparatus of claim 17, wherein the filter check valve does not comprise a spring, incline, or decline to bias the filter check valve movable body to either the rear position or forward position.

29. A method of using an injection molding filtration apparatus having a primary inlet and a primary outlet, the method comprising:
filtering a molten polymer comprising the substeps of
flowing the polymer from the primary inlet to the primary outlet through a filtration passage containing the filter, a filter check valve in an open position;
closing a bypass check valve to close a bypass line from the primary inlet to the primary outlet which bypasses a filter; and
decompressing equipment downstream from the filter apparatus, comprising the substeps of
closing the filter check valve;
opening the bypass check valve;
flowing the polymer from the primary outlet to the primary inlet through the bypass line.

30. The method of claim 30, wherein the step of decompressing the filter apparatus further comprises the substeps of
pushing a second filter valve sealing surface of the filter valve movable body toward a first filter valve sealing surface of the filter check valve with polymer downstream of the filter check valve, thereby closing the filter check valve; and
pushing a second bypass sealing surface of a bypass valve movable body away from a first bypass sealing surface of the bypass check valve with polymer downstream of the bypass check valve, thereby opening the bypass check valve.

31. The method of claim 30, wherein the step of decompressing further comprises the substep of flowing the polymer around the bypass check valve movable body through at least one passage in fluid communication with the primary inlet.

32. The method of claim 30, wherein the step of filtering a polymer further comprises the substeps of
pushing a second filter valve sealing surface of the filter valve movable body away from a first filter valve sealing surface with polymer upstream of the filter check valve, thereby opening the filter check valve; and
pushing a second bypass sealing surface of the bypass movable body into sealing engagement with a first bypass sealing surface of the bypass check valve with polymer upstream of the bypass check valve, thereby closing the bypass check valve.

33. The method of claim 33, further comprising the substep of flowing the polymer around the filter check valve movable body through at least one passage to an internal cavity of the filter.
